(19) United States
(12) Patent Application Publication
(10) Pub. No.: US 2004/0210333 A1
(43) Pub. Date: Oct. 21, 2004

(54) Photographic production system and photographic production programs

(75) Inventor: Shigeru Takeuchi, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA PHOTO IMAGING, INC., Tokyo (JP)

(21) Appl. No.: 10/823,022

(22) Filed: Apr. 12, 2004

(30) Foreign Application Priority Data
Apr. 18, 2003 (JP) JP2003-114823

(51) Int. Cl. G06F 19/00

(52) U.S. Cl. 700/99; 700/117

(57) ABSTRACT

The present invention relates to a photographic production system and photographic production programs to avoid duplicated processes and to complete the necessary processes on an alternative production line. The photographic production process comprises an order entry process, a character data input process, an image capturing process, a monitor judging process, an image synthesizing process and a printing process. A photographic production system having plural processes controlled under the photographic production system, including a memory process to store a necessary production process status of each process, a request-information generating process to generate request-information for processes, and when a process is interrupted, a request-information issuance process to issue request-information for processes to an alternative production line, a request-information receiving process to receive request-information for processes, and a result-information feedback process to process the work order based on the request-information for processes and to return information of process results.

### BACKGROUND OF THE INVENTION

The present invention relates to a photographic production system and photograph production programs to avoid duplicated processes and to complete necessary processes on an alternative production line.

### DESCRIPTION OF PRIOR ART

A photograph production process comprises, for example, an order entry process, a character data input process, an image capturing process, a monitor judging process, an image synthesizing process, printing process, etc.

It has been common, when a photographic production process encountered difficulty, the production is stopped and the process is re-started from the beginning in almost all cases, except that a re-starting process from the following process is possible only when a negative film exposing process has been completed.

Based on the above problem, it is impossible to avoid duplicated processes and it generates a great deal of lost time, extra labor and higher cost, and delivery delay in the worst cases.

### SUMMARY OF THE INVENTION

The objective of the present invention is to provide a photographic production system and photograph production processes to avoid duplicated processes and to continue the necessary process on an alternative production line.

The following are other objective of the present invention.

Each item below solves the above problems.

(1) A photographic production system, comprising, a first and a second print producing lines each of which comprises plural serial processing devices to produce a photographic printing in response to a work order from a customer to produce the photographic printing; wherein the first print producing line including, a monitoring section to monitor a working status of each of the plural serial processing devices of the first print producing line and to memorize the working status, a request-information generating section to generate request-information to request to conduct a process of one of the plural serial processing devices of the first print producing line on a basis of the working status, and a request-information issuing section to issue the request-information to the second print producing line; and the second print producing line including, a request-information receiving section to receive the request-information from the request-information issuing section, and a processing result returning section to make the corresponding one of the plural serial processing devices of the second print producing line to conduct the requested process and to return a processing result to the first print producing line.

(2) The photograph production system of item (1), wherein, the request-information to request to conduct a process including, identification of the second producing line, information about which processing devices have been completed; and information about which part of the processing device have been completed, when one of the processing device has not been completed.

(3) The photographic production system of (1) or (2), wherein, the second print producing line specified in the request-information includes at least a processing device, which is specified in the request-information to request to conduct a process to the second print producing line.

(4) The photographic production system of (1) or (2), wherein, the processing result includes which processing device has been completed, and processed data when a processing device, which has been specified in the request-information has been completed.

(5) The photographic production system of any one of (1)-(4), wherein, the request-information is issued when one of the serial processing devices is interrupted.

(6) A photographic production system for controlling a processing devices alternation between a first and a second photographic print producing lines, the first and the second print producing lines having a first computer and a second computer respectively and plural serial processing devices to produce the photographic printing in response to the work order from the customer to produce the photographic printing, comprising, the first computer in the first photographic print producing line including, a memory function to store working status of each of the plural serial processing devices of the first print producing line to complete the work order, a request-information generating function to generate request-information to conduct a process of one of the plural serial processing devices of the first print producing line on a basis of the working status, which is stored by the memory function, to the second photographic print producing line, and a request-information issuing function to issue the request-information generated by the request-information generating function; and the second computer in the second photographic print producing line including, a request-information receiving function to receive the request-information to conduct a process; and a processing result returning function to make the corresponding one of the plural serial processing devices of the second print producing line to conduct the requested process and to return a processing result to the first print producing line.

(7) The photographic production of (6), wherein the request-information to request to conduct a process of one of the plural serial processing devices of the first print producing line on a basis of the working status is issued when one of the plural serial producing devices is interrupted.

### BRIEF DESCRIPTION OF DRAWING

FIG. 1 shows a diagram of photograph production process, applicable to the present invention.

FIG. 2 shows a block diagram of an example of a photographic production system of the present invention.

FIG. 3 shows a workflow diagram when “monitor judging process proceeds to “an interruption”.

FIG. 4 shows a diagram requesting process shift to an alternative production line in the same facility.

FIG. 5 shows a diagram requesting process shift to an alternative production line in another facility.

FIG. 6 shows an example of a network system used along with a photographic production system of the present invention.

### DETAILED DESCRIPTION OF THE INVENTION

Following is an embodiment of the present invention.

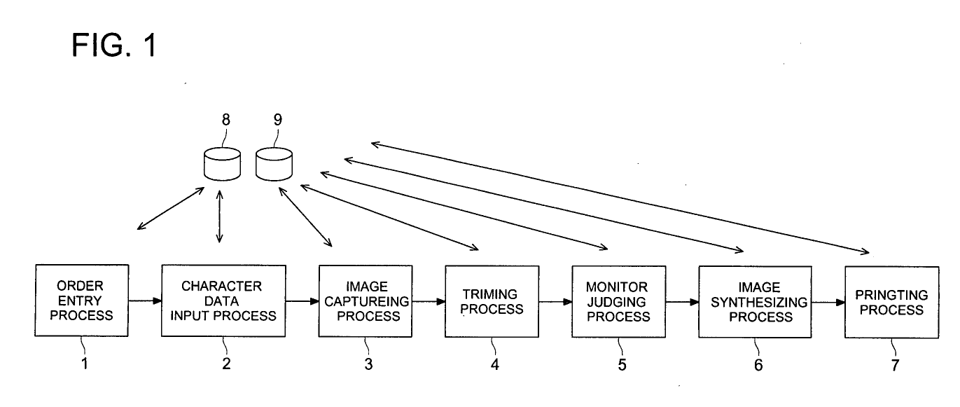

FIG. 1 shows a block diagram of one example applicable to a photographic production process of the present invention. Numeral 1 represents an order entry process, numeral 2 represents a character data input process, numeral 3 represents an image capturing process, numeral 4 represents a trimming process, numeral 5 represents a monitor judging process, numeral 6 represents an image synthesizing process, numeral 7 represents a printing process, numeral 8 represents a production control server and numeral 9 represents an image file-server.

Order entry process 1 represents the first step of the photographic production process, which enters customer order information such as a classification of a printing material, sizes, each image recorded on the film, the number of images, images, etc. It is acceptable to use information stored in the production control server 8 as the order entry information.

Character data input process 2 is the step to manually input character data based on the customer order information at the order entry process 1 by a keyboard. The information being keyed in can be stored in production control server 8.

Image capturing process 3 is the step to duplicate images of each image recorded on negative film, printed images, digital-camera images and images recorded on other kinds of media. Trimming process 4 is the step to manipulate (magnify, reduce and/or move) the images, which have been captured, based on the customer order information.

Monitor judging process 5 is a step to evaluate colors and optical density of the images, which have been captured and displayed on a monitor. Image synthesizing process 6 is the step to synthesize images based on the order entry information after completing the entry of data requiring for character data input process 2, image capturing process 3, trimming process 4 and monitor judging process 5. Printing process 7 is the step which distribute data to printing process based on an order entry information of data entry process 1 after necessary data conversion processing.

It is preferable to note and record work status of image capturing process 3, trimming process 4, monitor judging process 5, image synthesizing process 6 and printing process 7 into process control server 8 in order to remain aware of the status of each steps of overall processes.

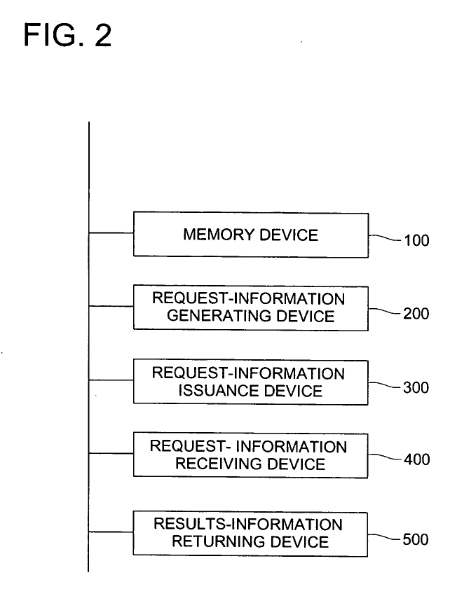

Following is an explanation of one of the examples of the photographic production system of the present invention shown in FIG. 2. Numeral 100 represents a memory device, which functions to store status of each step of overall processes to complete the work order. The status being stored by the memory device 100 includes the specific status of “process standby”, “process executed”, “process restarted” and “process completed”, which is stored by memory device 100.

“Process interrupted” is so defined that the photographic production system results in a situation in which machine trouble, etc. occurred; immediate recovery of the system is impossible; continued operation of the system is difficult due to the absence of the operator of the system; and the system enters a situation where operation of the system has to be shut down.

Process restart is so defined that the system is in an interrupted process situation and the process re-starts after resetting the interrupted situation upon receipt of information that an alternative production process has finished the interrupted process based on a request to proceed to subsequent steps of the production process.

Numeral 200 represents a request-information generating device to generate the request-information processes based on the status of each process stored by memory device 100 when the photographic production system is interrupted.

The request-information for processes is information requesting the process shift to an alternative production process. It is preferable that the request-information for processes includes information specifying the process being undertaken (information that specifies which step of the process should be undertaken), information identifying the acceptor of the process, information of the status of each process (which process has been completed). Furthermore, included is information to specify which steps of the process have been completed and details of the situation of the process (for example, information about the image sequence to be processed, should be specified), and when the process has not been completed.

Numeral 300 represents a request-information issuance device to issue request-information for processes, which has been generated by aforementioned request-information generating device 200. For example, generated request-information for processes is issued to an alternative production line from the production line in an interrupted process to request the unfinished process to be completed elsewhere. It is preferable that an alternative production line includes at least the process, which is specified in the request-information for processes.

Numeral 400 represents a request-information receiving device, which receives the request-information for processes generated by request-information issuance device 300. For example, an alternative production system or a production process receives the request-information for processes.

Numeral 500 represents result-information feedback device which returns information of process results to the requester after completion of the process based on the request-information for processes received by the alternate production system. It is preferable to provide the process results to the requester after completion of the requested process without unnecessary duplicated process.

It is preferable that the information of process results generated by result-information feedback device 500 includes information about which specific process has been completed, and the corresponding data.

Namely, the information of process results, which have been processed and completed by the alternative production process, is returned to the requester of the process. Basically, processed data and notification of the completion of the process are returned to the requester when the process is normally completed, and unprocessed data or original data is returned, when interruptions happen on the alternative production line.

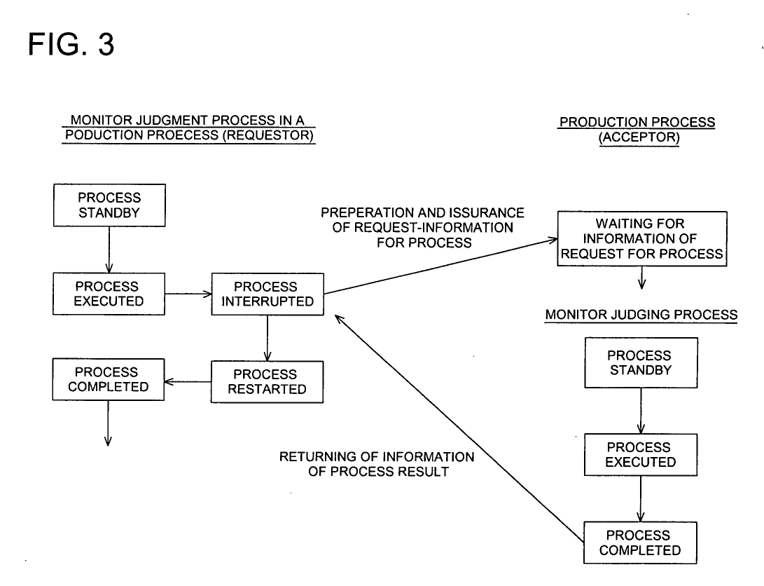

Next, a procedure, when monitor judging process in a photographic production process is interrupted, will be explained by using FIG. 3.

FIG. 3 shows a workflow between monitor judging process (requester) and an alternative production process (acceptor). An alternative production process is not limited to being conducted in the same facility but it could also be in other facilities.

In the requester side, memory device 100 store that a processing state is changing its aspect from “process standby”, “process executed” to “process interrupted”. The “a process interrupted” means that the process is interrupted at “monitor judging process”.

When production control server 8 (see FIG. 1) receives information of “process interrupted”, it instructs request-information generating device 200 to generate request-information for processes. Request-information issuance device 300 issues generated request-information for processes (information specifies which process has been completed) to a production process controlled under an acceptor.

Request-information receiving process in the acceptor side receives the request-information for processes issued by request-information issuance device 300, then the status changes from “process standby” to “process completed” through “process executed”. In the monitor judging process, monitor judging process is completed after passing through each step of “process standby”, “process executed” and “process completed” and information of process results are returned to the requester.

The requester receives the feedback information of process results and changes the status of the process from “process interrupted” to “process restart”. And then the process is completed after the status passes through “process restart” and “process complete”.

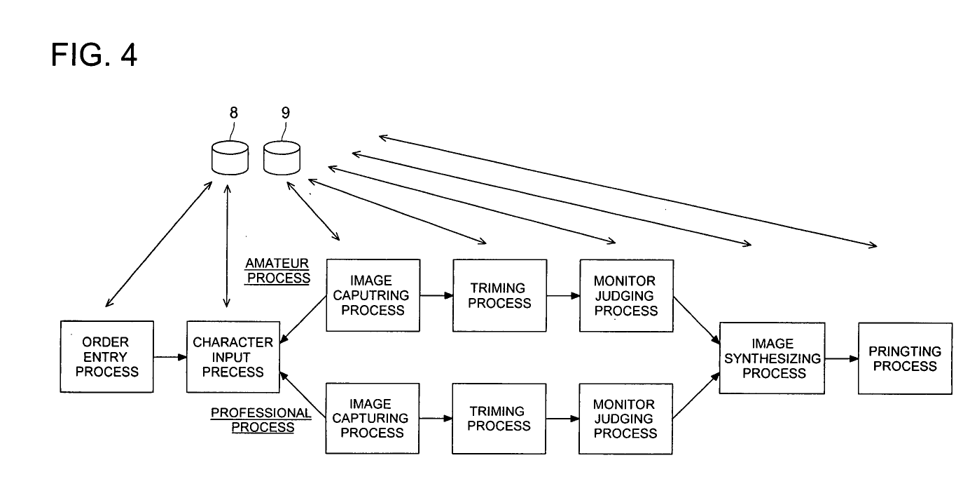

Next, an example, when a request-information for processes is issued to an alternative production line in the same facility, will be explained based on FIG. 4.

The example shown in FIG. 4 is one used when a requester has an amateur process production line production line (photographic process used for amateur photographers) and an acceptor has a professional process production line (photographic process used for professional photographers).

When a process is interrupted at the trimming process in the amateur process production line, the requester issues the request-information for process from the trimming process in the amateur process production line to the professional process production line in the acceptor side. The trimming process is completed at the acceptor side and then the information of process results of the trimming process is returned to the requester. In this case, any of the following selections, which are all the process from the image capturing process to the monitor judging process via the trimming process or the trimming process only can be completed in the acceptor side and can be returned to the requester side.

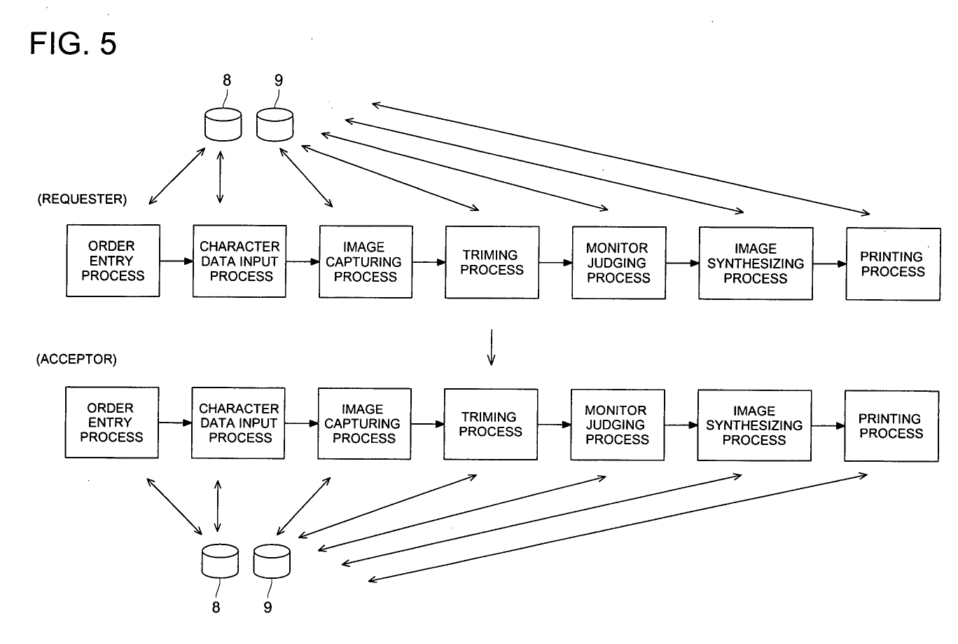

Next, an example when request-information for process is issued to an alternative production line in another facility will be explained based on FIG. 5.

FIG. 5 shows an example of the case that the same production line is used for both the requester side and request acceptor side. For example, when “an process interrupted” happens at the trimming process in the requester side, the request-information for process of trimming process is issued to the acceptor. Then the trimming process is completed and the information of trimming results are retuned the requester. In this case, processes from the trimming process to the monitor judging process, from the trimming process to the image synthesizing process or all processes from the trimming process to the printing process can be completed in the acceptor side and trimming process results can be returned to the requester as the information of process results.

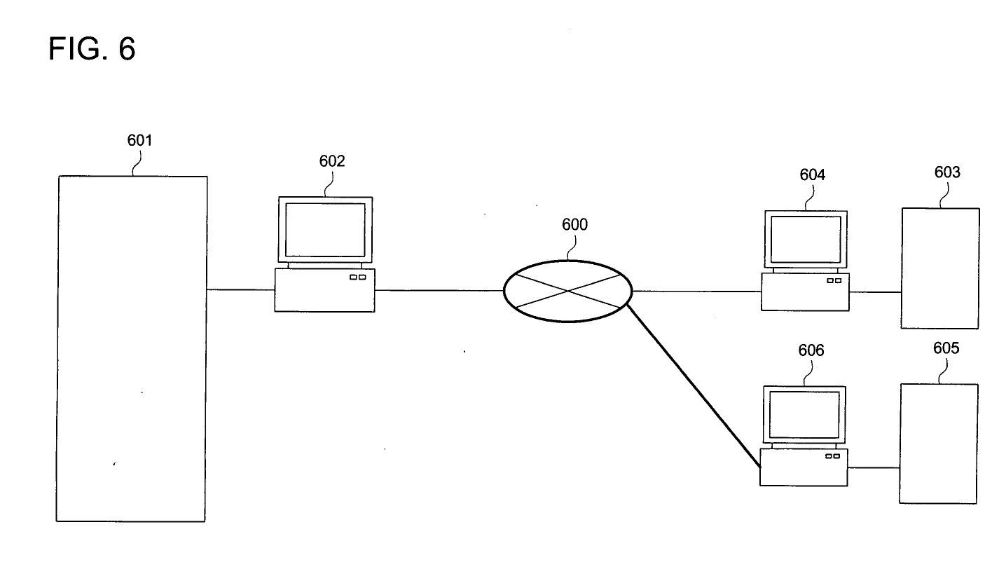

Preferable embodiments of the photographic production processes of the present invention have been explained as above. Furthermore as another example of an embodiment of the present invention, a network system used alongside the present invention will be explained as follows. An example that terminal 602 issues the request-information for processes from photographic production line 601 in the requester side to terminal 604 which controls photographic production system 603 in the acceptor side through network 600, and has the acceptor return the processed results to the requester and/or issues the request-information for processes to terminal 606, which controls photographic production system 605 of in the acceptor side and has the acceptor return processed results to the terminal 602 through network 600, is shown in FIG. 6. It is preferable that there are plural acceptors since a selection of acceptor is available. Specially, it is preferable that selection of a facility which has a specialty in trimming process, when requesting the trimming process.

In the above example, it is preferable that photographic production programs are installed in terminal 602 (as is a computer), which functions to store the process status of each necessary process of a work order, and functions to generate request-information for process based on the process status of each process stored by the memory program when a process is interrupted and functions to issue the request information for process to an alternative production line.

It is also preferable that photographic production programs in terminals 604 and 606 in an acceptor side, which function to receive request-information for processes, which has been issued, which function to return information of process results to a requester after completing processes based on the request-information for process.

The above programs can be installed to any terminal through Internet or from recorded media.

According to the present invention, a photographic production system and photographic production programs to avoid duplicated process and to coordinate necessary processes with other production lines. The above embodiments of the present invention are explained when one of the process is interrupted. However, the present invention is not limited to the situation of process interrupted but it can be also applicable when requesting a specific process to other acceptors without process interrupted.

1. A photographic production system, comprising:
a first and a second print producing lines each of which comprises plural serial processing devices to produce a photographic printing in response to a work order from a customer to produce the photographic printing;
the first print producing line including:
a monitoring section to monitor a working status of each of the plural serial processing devices of the first print producing line and to memorize the working status,
a request-information generating section to generate request-information to request to conduct a process of one of the plural serial processing devices of the first print producing line on a basis of the working status, and
a request-information issuing section to issue the request-information to the second print producing line; and the second print producing line including: and
a request-information receiving section to receive the request-information from the request-information issuing section, and
a processing result returning section to make the corresponding one of the plural serial processing devices of the second print producing line to conduct the requested process and to return a processing result to the first print producing line.

2. The photograph production system of claim 1, wherein, the request-information to request to conduct a process including:
identification of the second producing line;
information about which processing devices have been completed; and,
information about which part of the processing device have been completed, when one of the processing device has not been completed.

3. The photographic production system of claim 1 wherein, the second print producing line specified in the request-information includes at least a processing device, which is specified in the request-information to request to conduct a process to the second print producing line.

4. The photographic production system of claim 1 wherein, the processing result includes which processing device has been completed, and processed data when a processing device, which has been specified in the requestinformation has been completed.

5. The photographic production system of claim 1, wherein, the request-information is issued when one of the serial processing devices is interrupted.

6. A photographic production system for controlling a processing devices alternation between a first and a second photographic print producing lines, the first and the second print producing lines having a first computer and a second computer respectively and plural serial processing devices to produce the photographic printing in response to the work order from the customer to produce the photographic printing, comprising:
the first computer in the first photographic print producing line including:
a memory function to store working status of each of the plural serial processing devices of the first print producing line to complete the work order;
a request-information generating function to generate request-information to conduct a process of one of the plural serial processing devices of the first print producing line on a basis of the working status, which is stored by the memory function, to the second photographic print producing line; and a request-information issuing function to issue the request-information generated by the requestinformation generating function; and the second computer in the second photographic print producing line including:
a request-information receiving function to receive the request-information to conduct a process; and
a processing result returning function to make the corresponding one of the plural serial processing devices of the second print producing line to conduct the requested process and to return a processing result to the first print producing line.

7. The photographic production of claim 6, wherein the request-information to request to conduct a process of one of the plural serial processing devices of the first print producing line on a basis of the working status is issued when one of the plural serial producing devices is interrupted.

8. The photographic production system of claim 2, wherein, the second print producing line specified in the request-information includes at least a processing device, which is specified in the request-information to request to conduct a process to the second print producing line.

9. The photographic production system of claim 2, wherein, the processing result includes which processing device has been completed, and processed data when a processing device, which has been specified in the request information has been completed.

10. The photographic production system of claim 2, wherein, the request-information is issued when one of the serial processing devices is interrupted.

11. The photographic production system of claim 3, wherein, the request-information is issued when one of the serial processing devices is interrupted.

12. The photographic production system of claim 4, wherein, the request-information is issued when one of the serial processing devices is interrupted.

13. The photographic production system of claim 8, wherein, the request-information is issued when one of the serial processing devices is interrupted.

14. The photographic production system of claim 9, wherein, the request-information is issued when one of the serial processing devices is interrupted.
